(19) United States
(12) Patent Application Publication
(10) Pub. No.: US 2026/0160649 A1
(43) Pub. Date: Jun. 11, 2026

(54) EXHAUST SAMPLER

(71) Applicant: Cummins Emission Solutions Inc., Columbus, IN (US)

(72) Inventors: Tushar Sudam Udhane, Pune (IN); Atul N Bamane, Raigad (IN); Randolph G Zoran, McFarland, WI (US)

(73) Assignee: Cummins Emission Solutions Inc., Columbus, IN (US)

(21) Appl. No.: 18/973,723

(22) Filed: Dec. 9, 2024

(51) Int. Cl. G01N 1/22; F01N 11/00

(52) U.S. Cl. CPC G01N 1/2252; F01N 11/00

(57) ABSTRACT

An exhaust sampler includes a sensor assembly enclosure. A portion of the exhaust sampler is coupled to an exhaust conduit in an exhaust aftertreatment system. A sensor is coupled to the exhaust conduit and configured to monitor a level of at least one constituent in exhaust. The exhaust sampler is positioned around the sensor. The sensor protrudes through the sensor assembly enclosure. The exhaust sampler is configured to receive a portion of exhaust in the exhaust conduit through an inlet, route the portion of exhaust to the sensor for sampling, and route the portion of exhaust back into the exhaust conduit through an outlet.

### TECHNICAL FIELD

The present disclosure relates generally to an exhaust sampler for an exhaust aftertreatment system. The exhaust sampler routes exhaust to a sensor for sampling (i.e., for determining a composition of the exhaust, etc.).

### BACKGROUND

For an exhaust aftertreatment system, it may be desirable to monitor emissions in exhaust to properly treat the emissions. One approach that can be implemented to monitor the emissions is to include an exhaust sampler in an exhaust conduit to route a portion of the exhaust to a sensor coupled to the exhaust conduit to monitor a level of at least one constituent in the exhaust. However, some configurations of the exhaust sampler may result in undesirable performance and inaccurate measurements of the constituents.

### SUMMARY

In various embodiments, an exhaust sampler includes a sensor assembly enclosure, a collector, and a transfer tube. The sensor assembly enclosure includes an enclosure body, an enclosure inlet extending through the enclosure body, and an enclosure outlet extending through the body, the enclosure outlet having an outlet area. The collector includes a collector body, a collector inlet, and a collector outlet. The collector body includes a collector upstream end and a collector downstream end opposite the collector upstream end. The collector body also includes a collector wall extending from the collector upstream end to the collector downstream end. In various embodiments, the collector body is bell shaped or is frustoconical. In various embodiments, the enclosure body has a first volume, the collector body has a second volume, and the second volume is between 40% of the first volume and 70% of the first volume, inclusive. The collector inlet is defined by the collector body at the collector upstream end. The collector outlet extends through the collector wall. The transfer tube includes a transfer tube body, a tube inlet, and a tube outlet. The transfer tube body includes a tube inlet end and a tube outlet end opposite the tube inlet end. The transfer tube body includes a tube wall extending from the tube inlet end to the tube outlet end. The tube wall is coupled to the collector wall around the collector outlet and to the enclosure body around the enclosure inlet. In various embodiments, the tube wall protrudes through at least one of the collector outlet or the enclosure inlet. The tube inlet is defined by the tube wall at the tube inlet end. The tube inlet has an inlet area between 105% and 200% of the outlet area, inclusive. The tube outlet is defined by the tube wall at the tube outlet end. In various embodiments, an exhaust aftertreatment system includes a catalyst exhaust conduit, a sensor coupled to the catalyst exhaust conduit and the exhaust sampler described in the embodiment. The exhaust sampler further includes a sensor aperture extending through the enclosure body and the sensor projects through the sensor aperture into the enclosure body. In various embodiments, the transfer tube has a first center axis, the sensor has a second center axis, and the second center axis is collinear with the first center axis.

In various embodiments, an exhaust sampler includes a sensor assembly enclosure, an inlet, an outlet, and a baffle plate assembly. The sensor assembly enclosure includes an upstream portion, a downstream portion, an enclosure wall extending between the upstream portion and the downstream portion, and an endcap extending between the upstream portion, the downstream portion, and the enclosure wall. The endcap cooperates with the upstream portion, the downstream portion, and the enclosure wall to define a sampler cavity. The inlet extends through the upstream portion and the inlet having an inlet area. The outlet extends through the downstream portion and the outlet has an outlet area. The outlet area is between 20% and 40% of the inlet area, inclusive. The baffle plate assembly is disposed in the sampler cavity. The baffle plate assembly includes a baffle plate coupled to the endcap. The baffle plate extends between the upstream portion and the downstream portion away from the endcap in a first direction orthogonal to the endcap. The baffle plate has a plate height in the first direction. The outlet has an outlet height in the first direction and the plate height is greater than the outlet height. In various embodiments, the upstream portion has an upstream portion height in the first direction and the plate height is between 65% and 85% of the upstream portion height, inclusive. In various embodiments, the inlet has an inlet height in the first direction and the plate height is between 70% and 90% of the inlet height, inclusive. In various embodiments, the upstream portion has a first radius of curvature, the downstream portion has a second radius of curvature, and the upstream portion and the downstream portion are configured such that a ratio of the first radius of curvature to the second radius of curvature is between 0.5 and 1.5, inclusive. In various embodiments, the upstream portion has an upstream portion area, the downstream portion has a downstream portion area, and the downstream portion area is between 105% and 200% of the upstream portion area, inclusive. In various embodiments, the upstream portion has an upstream portion area, the downstream portion has a downstream portion area, and the downstream portion area is between 50% and 95% of the upstream portion area, inclusive. In various embodiments, the inlet has an inlet bottom edge and an inlet top edge. The inlet bottom edge has an inlet bottom edge width in a second direction orthogonal to the first direction. The second direction does not intersect the downstream portion or the enclosure wall. The inlet top edge has an inlet top edge width in the second direction. In such embodiments, the inlet top edge width is less than the inlet bottom edge width and the inlet top edge is parallel to the inlet bottom edge. In various embodiments, the outlet has an outlet bottom edge and an outlet top edge. The outlet bottom edge has an outlet bottom edge width in a second direction orthogonal to the first direction. The second direction does not intersect the upstream portion or the enclosure wall. The outlet top edge has an outlet top edge width in the second direction. The outlet top edge width is between 95% and 105% of the outlet bottom edge width, inclusive. The outlet top edge is parallel to the outlet bottom edge. In various embodiments, an exhaust aftertreatment system includes a catalyst exhaust conduit, a sensor coupled to the catalyst exhaust conduit and the exhaust sampler described in the embodiment. The enclosure wall is coupled to the catalyst exhaust conduit around the sensor and the sensor projects into the sensor assembly enclosure. The sensor has an end face on a sensor endcap of the sensor and the end face is separated from the endcap by a sensor height in the first direction. The sensor height is greater than the plate height.

In various embodiments, the exhaust sampler further includes a second baffle plate assembly. The second baffle plate assembly includes a second baffle plate coupled to the endcap and extending between the upstream portion and the downstream portion in the first direction. The second baffle plate has a second plate height in the first direction, and the second plate height is greater than the outlet height. In various embodiments, the second baffle plate assembly is separated from a centroid of the upstream portion by a second baffle distance in a second direction orthogonal to the first direction and the baffle plate assembly is separated from the centroid by a first baffle distance in the second direction. The second direction extends through the centroid. The first baffle distance is greater than the second baffle distance. In various embodiments, an exhaust aftertreatment system includes a catalyst exhaust conduit, a sensor coupled to the catalyst exhaust conduit and the exhaust sampler described in the embodiment. The enclosure wall is coupled to the catalyst exhaust conduit around the sensor and the sensor projects into the sensor assembly enclosure. In various embodiments, the second baffle plate assembly is separated from a centroid of the upstream portion by a second baffle distance in a second direction orthogonal to the first direction, the baffle plate assembly is separated from the centroid by a first baffle distance in the second direction, and the sensor is separated from the centroid by a sensor distance in the second direction. The second direction extends through the centroid. The sensor distance is greater than the second baffle distance and the first baffle distance is greater than the sensor distance.

### BRIEF DESCRIPTION OF THE DRAWINGS

The disclosure will become more fully understood from the following detailed description, taken in conjunction with the accompanying Figures, in which like reference numerals refer to like elements unless otherwise indicated, in which:

FIG. 1 is a schematic diagram of an example exhaust aftertreatment system including a housing assembly with a distributing housing;

FIG. 2 is a schematic diagram of an example first catalyst exhaust conduit;

FIG. 3 is a perspective view of an example exhaust sampler for an exhaust aftertreatment system;

FIG. 4 is a cross-sectional view of the exhaust sampler shown in FIG. 3 taken along plane A-A;

FIG. 5 is another perspective view of the exhaust sampler shown in FIG. 3;

FIG. 6 is a perspective view of the collector shown in FIG. 3;

FIG. 7 is a cross-sectional view of the exhaust sampler shown in FIG. 3 positioned in a first catalyst exhaust conduit;

FIG. 8 is a perspective view of another example exhaust sampler for an exhaust aftertreatment system;

FIG. 9 is a view of Detail A shown in FIG. 8;

FIG. 10 is a cross-sectional view of the exhaust sampler shown in FIG. 8 taken along plane B-B;

FIG. 11 is another perspective view of the exhaust sampler shown in FIG. 8;

FIG. 12 is a schematic diagram of an example inlet for the exhaust sampler shown in FIG. 8;

FIG. 13 is a schematic diagram of an example outlet for the exhaust sampler shown in FIG. 8;

FIG. 14 is a cross-sectional view of the exhaust sampler shown in FIG. 8 positioned in a first catalyst exhaust conduit;

FIG. 15 is a perspective view of two example exhaust samplers for an exhaust aftertreatment system superimposed on one another; and

FIG. 16 is a cross-sectional view of another example exhaust sampler positioned in a first catalyst exhaust conduit.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of, methods, apparatuses, and for an exhaust sampler of an exhaust aftertreatment system. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

To monitor emissions in exhaust to properly treat the emission, it may be desirable to monitor and measure a level of at least one constituent in the exhaust. For example, a sensor coupled to an exhaust conduit can measure the level of at least one constituent and a controller that the sensor is connected to can adjust the treatment of the emissions based on the level. One approach to measuring the level of at least one constituent is to include an exhaust sampler in the exhaust conduit of an exhaust aftertreatment system that directs a portion of the exhaust to the sensor coupled to the exhaust conduit. However, the configuration of the exhaust sampler may result in increased backpressure and/or a decrease in the velocity at which the exhaust reaches the sensor. These can negatively impact the exhaust aftertreatment system and the measurements of the level of at least one constituent.

Implementations described herein are related to an exhaust sampler for an exhaust aftertreatment system. The exhaust sampler routes exhaust to a sensor for sampling. A portion of the exhaust from a catalyst member flows through the exhaust sampler and is directed towards the sensor coupled to an exhaust conduit. By configuring the exhaust sampler, the exhaust reaches the sensor at a desirable velocity resulting in desirable measurements. In addition, the configuration of the exhaust sampler results in less backpressure in some applications. Additionally, the portion of the exhaust that flows through the exhaust sampler flows out of the exhaust sampler and back into the catalyst member. In this way, the exhaust sampler does not significantly affect the flow of the exhaust aftertreatment system.

### II. Overview of Exhaust Aftertreatment System

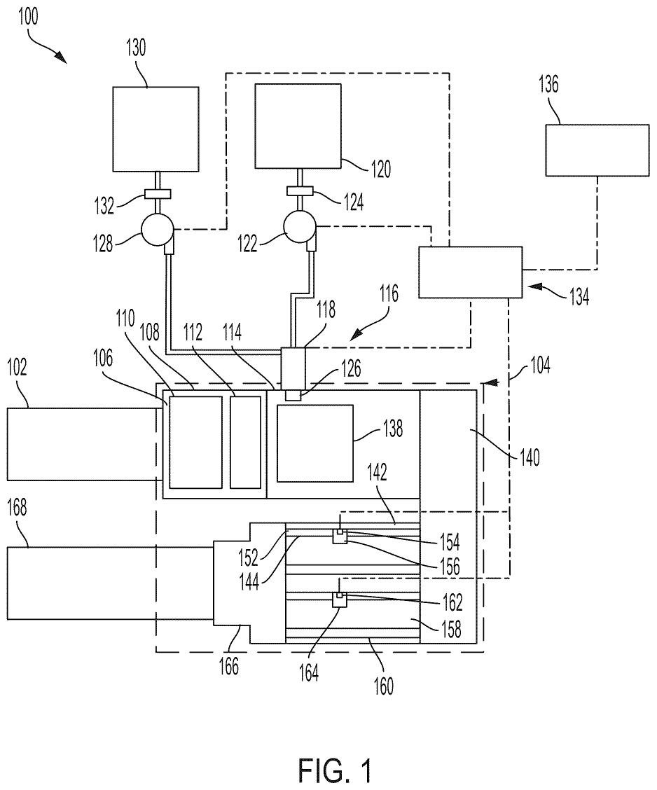

FIG. 1 depicts an exhaust aftertreatment system 100 (e.g., treatment system, etc.) for treating emissions produced by an internal combustion engine (e.g., diesel internal combustion engine, gasoline internal combustion engine, hybrid internal combustion engine, propane internal combustion engine, dual-fuel internal combustion engine, etc.). The exhaust aftertreatment system 100 includes an upstream exhaust conduit 102 (e.g., line, pipe, etc.). The upstream exhaust conduit 102 is fluidly coupled to an upstream component (e.g., header, exhaust manifold, etc.) and is configured to receive exhaust from the upstream component. In some embodiments, the upstream exhaust conduit 102 is coupled to (e.g., attached to, fixed to, welded to, fastened to, riveted to, etc.) the internal combustion engine (e.g., the upstream exhaust conduit 102 is coupled to an outlet of the internal combustion engine, etc.). In other embodiments, the upstream exhaust conduit 102 is integrally formed with the internal combustion engine.

The exhaust aftertreatment system 100 also includes a housing assembly 104. As is explained in more detail herein, the housing assembly 104 is configured to redirect the exhaust (e.g., from a first direction to a second direction etc.) while facilitating treatment of the exhaust. In redirecting the exhaust, the housing assembly 104 may function as a switchback (e.g., redirecting the exhaust from a first direction to a second direction that is opposite to the first direction, redirecting the exhaust from a first direction to a second direction that is opposite to the first direction and parallel to the first direction, etc.).

The housing assembly 104 includes an intake body 106 (e.g., chamber, etc.). The intake body 106 is fluidly coupled to the upstream exhaust conduit 102 and is configured to receive exhaust from the upstream exhaust conduit 102. The intake body 106 may be configured to redirect the exhaust from a first direction (e.g., extending along a center axis of the upstream exhaust conduit 102, etc.) to a second direction (e.g., that is orthogonal to the first direction, etc.).

The housing assembly 104 also includes an upstream housing 108 (e.g., chamber, body, etc.). The upstream housing 108 is fluidly coupled to the intake body 106 and is configured to receive exhaust from the intake body 106. In various embodiments, the upstream housing 108 is coupled to the intake body 106. For example, the upstream housing 108 may be fastened (e.g., using a band, using bolts, etc.), welded, riveted, or otherwise attached to the intake body 106. In other embodiments, the upstream housing 108 is integrally formed with (e.g., unitarily formed with, formed as a one-piece construction with, inseparable from, etc.) the intake body 106.

In some embodiments, the housing assembly 104 includes a heater (e.g., electrical heater, resistance heater, fluid heat exchanger, etc.) that is configured to heat the exhaust in the intake body 106 and/or the upstream housing 108. For example, the housing assembly 104 may include a heater that extends in the intake body 106 and is configured to heat the exhaust in the intake body 106. By heating the exhaust, an ability of catalyst members to desirably perform catalytic reactions may be increased. Additionally, heating the exhaust may facilitate regeneration (e.g., burn-off of particulates, etc.) of various components of the exhaust aftertreatment system 100.

The exhaust aftertreatment system 100 also includes an oxidation catalyst 110 (e.g., a diesel oxidation catalyst (DOC), etc.). At least a portion of the oxidation catalyst 110 is positioned in (e.g., contained in, housed in, located in, etc.) the upstream housing 108. In various embodiments, the oxidation catalyst 110 is positioned in the upstream housing 108 and the intake body 106. In other embodiments, the oxidation catalyst 110 is positioned in the upstream housing 108 and is not positioned in the intake body 106. In still other embodiments, the oxidation catalyst 110 is positioned in the intake body 106 and is not positioned in the upstream housing 108.

The exhaust is provided by the intake body 106 to the oxidation catalyst 110. The oxidation catalyst 110 may be configured to oxidize hydrocarbons and/or carbon monoxide in the exhaust. In this way, the oxidation catalyst 110 may remove hydrocarbons and/or carbon monoxide from the exhaust prior to the exhaust being provided to downstream components of the exhaust aftertreatment system 100. The oxidation catalyst 110 may be positioned in the intake body 106 and/or the upstream housing 108 (e.g., using a gasket, using a spacer, using a seal, etc.) such that flow of the exhaust between the oxidation catalyst 110 and the intake body 106 and/or between the oxidation catalyst 110 and the upstream housing 108 is substantially prevented (e.g., less than 1% of the exhaust flow received by the intake body 106 flows between the oxidation catalyst 110 and the intake body 106, less than 1% of the exhaust flow received by the intake body 106 flows between the oxidation catalyst 110 and the upstream housing 108, etc.).

The exhaust aftertreatment system 100 also includes an exhaust filtration device 112 (e.g., a diesel particulate filter (DPF), etc.). The exhaust filtration device 112 is positioned in the upstream housing 108 downstream of the oxidation catalyst 110. The exhaust is provided by the oxidation catalyst 110 into the upstream housing 108 (e.g., between the oxidation catalyst 110, the upstream housing 108, and the exhaust filtration device 112, etc.) and subsequently into the exhaust filtration device 112 (e.g., after hydrocarbons in the exhaust have been oxidized by the oxidation catalyst 110, after carbon monoxide in the exhaust has been oxidized by the oxidation catalyst 110, etc.). The exhaust filtration device 112 may remove particulates (e.g., soot, etc.) from the exhaust prior to the exhaust being provided to downstream components of the exhaust aftertreatment system 100. The exhaust filtration device 112 may be positioned in the upstream housing 108 (e.g., using a gasket, using a spacer, using a seal, etc.) such that flow of the exhaust between the exhaust filtration device 112 and the upstream housing 108 is substantially prevented (e.g., less than 1% of the exhaust flow received by the intake body 106 flows between the exhaust filtration device 112 and the upstream housing 108, etc.).

The housing assembly 104 also includes a decomposition housing 114 (e.g., decomposition reactor, decomposition chamber, reactor pipe, decomposition tube, reactor tube, etc.). The decomposition housing 114 is fluidly coupled to the upstream housing 108 and is configured to receive exhaust from the upstream housing 108. In various embodiments, the decomposition housing 114 is coupled to the upstream housing 108. For example, the decomposition housing 114 may be fastened (e.g., using a band, using bolts, etc.), welded, riveted, or otherwise attached to the upstream housing 108. In other embodiments, the decomposition housing 114 is integrally formed with the upstream housing 108.

The decomposition housing 114 is located downstream of the exhaust filtration device 112 and receives the exhaust from the exhaust filtration device 112 (e.g., after particulates have been removed from the exhaust by the exhaust filtration device 112, etc.). As is explained in more detail herein, the decomposition housing 114 is configured to facilitate introduction of reductant (e.g., diesel exhaust fluid (DEF), Adblue®, a urea-water solution (UWS), an aqueous urea solution (e.g., AUS32, etc.), into the exhaust, so as to facilitate reduction of emission of undesirable components (e.g., nitrogen oxides (NOx), etc.) in the exhaust.

The exhaust aftertreatment system 100 also includes a reductant delivery system 116. As is explained in more detail herein, the reductant delivery system 116 is configured to facilitate the introduction of the reductant into the exhaust. The reductant delivery system 116 includes a dosing module 118 (e.g., doser, etc.). The dosing module 118 is configured to facilitate passage of the reductant through the decomposition housing 114 and into the decomposition housing 114. As is explained in more detail herein, the dosing module 118 is configured to receive reductant, and in some embodiments, configured to receive air and reductant, and provide the reductant and/or air-reductant mixture into the decomposition housing 114 to facilitate treatment of the exhaust. The dosing module 118 may include an insulator interposed between a portion of the dosing module 118 and the portion of the decomposition housing 114 on which the dosing module 118 is mounted. In various embodiments, the dosing module 118 is coupled to the decomposition housing 114.

The reductant delivery system 116 also includes a reductant source 120 (e.g., reductant tank, etc.). The reductant source 120 is configured to contain reductant. The reductant source 120 is fluidly coupled to the dosing module 118 and configured to provide the reductant to the dosing module 118. The reductant source 120 may include multiple reductant sources 120 (e.g., multiple tanks connected in series or in parallel, etc.). The reductant source 120 may be, for example, a diesel exhaust fluid tank containing Adblue®.

The reductant delivery system 116 also includes a reductant pump 122 (e.g., supply unit, etc.). The reductant pump 122 is fluidly coupled to the reductant source 120 and the dosing module 118 and configured to receive the reductant from the reductant source 120 and to provide the reductant to the dosing module 118. The reductant pump 122 is used to pressurize the reductant from the reductant source 120 for delivery to the dosing module 118. In some embodiments, the reductant pump 122 is pressure controlled. In some embodiments, the reductant pump 122 is coupled to a chassis of a vehicle associated with the exhaust aftertreatment system 100.

In some embodiments, the reductant delivery system 116 also includes a reductant filter 124. The reductant filter 124 is fluidly coupled to the reductant source 120 and the reductant pump 122 and is configured to receive the reductant from the reductant source 120 and to provide the reductant to the reductant pump 122. The reductant filter 124 filters the reductant prior to the reductant being provided to internal components of the reductant pump 122. For example, the reductant filter 124 may inhibit or prevent the transmission of solids to the internal components of the reductant pump 122. In this way, the reductant filter 124 may facilitate prolonged desirable operation of the reductant pump 122.

The dosing module 118 includes at least one injector 126 (e.g., insertion device, etc.). The injector 126 is fluidly coupled to the reductant pump 122 and configured to receive the reductant from the reductant pump 122. The injector 126 is configured to dose (e.g., inject, insert, etc.) the reductant received by the dosing module 118 into the exhaust in the decomposition housing 114.

In some embodiments, the reductant delivery system 116 also includes an air pump 128 and an air source 130 (e.g., air intake, etc.). The air pump 128 is fluidly coupled to the air source 130 and is configured to receive air from the air source 130. The air pump 128 is fluidly coupled to the dosing module 118 and is configured to provide the air to the dosing module 118. The dosing module 118 is configured to mix the air and the reductant into an air-reductant mixture and to provide the air-reductant mixture to the injector 126 (e.g., for dosing into the exhaust in the decomposition housing 114, etc.). The injector 126 is fluidly coupled to the air pump 128 and configured to receive the air from the air pump 128. The injector 126 is configured to dose the air-reductant mixture into the exhaust in the decomposition housing 114. In some of these embodiments, the reductant delivery system 116 also includes an air filter 132. The air filter 132 is fluidly coupled to the air source 130 and the air pump 128 and is configured to receive the air from the air source 130 and to provide the air to the air pump 128. The air filter 132 is configured to filter the air prior to the air being provided to the air pump 128. In other embodiments, the reductant delivery system 116 does not include the air pump 128 and/or the reductant delivery system 116 does not include the air source 130. In such embodiments, the dosing module 118 is not configured to mix the reductant with air.

In various embodiments, the dosing module 118 is configured to receive air and reductant and dose the air-reductant mixture into the decomposition housing 114. In various embodiments, the dosing module 118 is configured to receive reductant (and does not receive air) and dose the reductant into the decomposition housing 114.

The exhaust aftertreatment system 100 also includes a controller 134 (e.g., control circuit, driver, etc.). The dosing module 118, the reductant pump 122, and the air pump 128 are also electrically or communicatively coupled to the controller 134. The controller 134 is configured to control the dosing module 118 to dose the reductant and/or the air-reductant mixture into the decomposition housing 114. The controller 134 may also be configured to control the reductant pump 122 and/or the air pump 128 in order to control the reductant and/or the air-reductant mixture that is dosed into the decomposition housing 114.

The controller 134 includes a processing circuit. The processing circuit includes a processor and a memory. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing a processor, ASIC, FPGA, etc. with program instructions. This memory may include a memory chip, Electrically Erasable Programmable Read-Only Memory (EEPROM), Erasable Programmable Read Only Memory (EPROM), flash memory, or any other suitable memory from which the controller 134 can read instructions. The instructions may include code from any suitable programming language. The memory may include various modules that include instructions which are configured to be implemented by the processor.

In various embodiments, the controller 134 is configured to communicate with a central controller 136 (e.g., engine control unit (ECU), engine control module (ECM), etc.) of an internal combustion engine having the exhaust aftertreatment system 100. In some embodiments, the central controller 136 and the controller 134 are integrated into a single controller.

In some embodiments, the central controller 136 is communicable with a display device (e.g., screen, monitor, touch screen, heads up display (HUD), indicator light, etc.). The display device may be configured to change state in response to receiving information from the central controller 136. For example, the display device may be configured to change between a static state and an alarm state based on a communication from the central controller 136. By changing state, the display device may provide an indication to a user of a status of the reductant delivery system 116.

In various embodiments, the exhaust aftertreatment system 100 also includes a mixer 138 (e.g., a swirl generating device, a vaned plate, etc., etc.). At least a portion of the mixer 138 is positioned in the decomposition housing 114. The mixer 138 is configured to receive the exhaust from the exhaust filtration device 112 (e.g., after particulates have been removed from the exhaust by the exhaust filtration device 112, etc.). The mixer 138 is also configured to the reductant and/or the air-reductant mixture from the injector 126. The mixer 138 is configured to facilitate swirling (e.g., tumbling, rotation, etc.) of the exhaust and mixing (e.g., combination, etc.) of the exhaust and the reductant or the air-reductant mixture so as to disperse the reductant in the exhaust downstream of the mixer 138. By dispersing the reductant in the exhaust (e.g., to obtain an increased uniformity index, etc.) using the mixer 138, reduction of emission of undesirable components in the exhaust is enhanced.

The housing assembly 104 also includes a distributing housing 140 (e.g., pressure regulator, flow plenum, flow balancer, flow balancing system, etc.). The distributing housing 140 is fluidly coupled to the decomposition housing 114 and is configured to receive exhaust from the decomposition housing 114 (e.g., after the reductant has been provided into the exhaust by the injector 126 and the reductant and the exhaust have been mixed by the mixer 138, etc.). In various embodiments, the distributing housing 140 is coupled to the decomposition housing 114. For example, the distributing housing 140 may be fastened, welded, riveted, or otherwise attached to the decomposition housing 114. In other embodiments, the distributing housing 140 is integrally formed with the decomposition housing 114.

The housing assembly 104 also includes a catalyst member housing 142 (e.g., body, etc.). The catalyst member housing 142 is fluidly coupled to the distributing housing 140 and is configured to receive exhaust from the distributing housing 140. In various embodiments, the catalyst member housing 142 is coupled to the distributing housing 140. For example, the catalyst member housing 142 may be fastened, welded, riveted, or otherwise attached to the distributing housing 140. In other embodiments, the catalyst member housing 142 is integrally formed with the distributing housing 140. The catalyst member housing 142 is located downstream of the distributing housing 140 and receives the exhaust from the distributing housing 140.

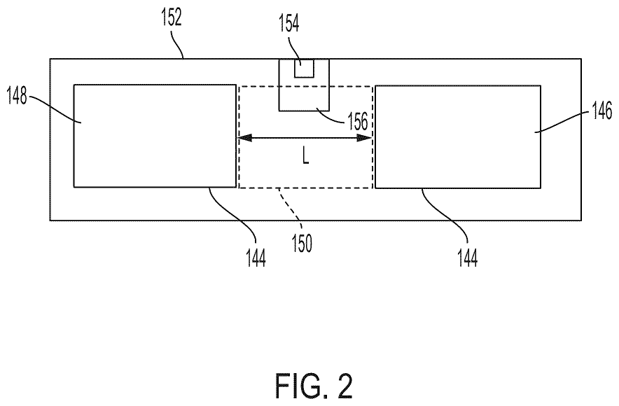

The exhaust aftertreatment system 100 also includes a first catalyst member 144 (e.g., first selective catalytic reduction (SCR) catalyst member, etc.). The first catalyst member 144 is configured to receive, treat, and output a first portion of the exhaust output by the distributing housing 140. At least a portion of the first catalyst member 144 is positioned in the catalyst member housing 142. The first portion of the exhaust received by the distributing housing 140 is provided by the distributing housing 140 to the first catalyst member 144 (e.g., via the catalyst member housing 142, etc.). In various embodiments, as is shown in FIG. 2, the first catalyst member 144 includes an upstream portion 146 and a downstream portion 148. The upstream portion 146 is positioned upstream of the flow of the first portion of the exhaust received by the distributing housing 140. The downstream portion 148 is positioned downstream of the upstream portion 146 in the direction of the flow of the first portion of the exhaust received by the distributing housing 140. The upstream portion 146 is separated from the downstream portion 148 by a gap 150.

As is explained in more detail herein, the first catalyst member 144 is configured to cause decomposition of components of the exhaust using the reductant (e.g., via catalytic reactions, etc.). Specifically, reductant that has been provided into the exhaust by the injector 126 undergoes the processes of evaporation, thermolysis, and hydrolysis to form non-NOx emissions in the distributing housing 140, the catalyst member housing 142, the first catalyst member 144, and/or the housing assembly 104. The first catalyst member 144 is configured to assist in the reduction of NOx emissions by accelerating a NOx reduction process between the reductant and the NOx of the exhaust into diatomic nitrogen, water, and/or carbon dioxide.

The exhaust aftertreatment system 100 also includes a first catalyst exhaust conduit 152. The first catalyst exhaust conduit 152 is coupled to the distributing housing 140. For example, the first catalyst exhaust conduit 152 may be fastened, welded, riveted, or otherwise attached to the distributing housing 140. The first catalyst member 144 is disposed in the first catalyst exhaust conduit 152. In various embodiments, at least a portion of the first catalyst exhaust conduit 152 is positioned in the catalyst member housing 142.

The exhaust aftertreatment system 100 also includes a first sensor 154. The first sensor 154 is coupled to the first catalyst exhaust conduit 152. For example, the first sensor 154 may be fastened, welded, riveted, or otherwise attached to the first catalyst exhaust conduit 152. At least a portion of the first sensor 154 is in the first catalyst exhaust conduit 152. In embodiments where the first catalyst member 144 includes an upstream portion 146 and a downstream portion 148, as is shown in FIG. 2, the first sensor 154 may be positioned at a gap 150 between the upstream portion 146 and the downstream portion 148. In various embodiments, the gap 150 has a gap length L that is equal to between 20% of a diameter of the first catalyst exhaust conduit 152 and 80% of the diameter of the first catalyst exhaust conduit 152, inclusive.

The first sensor 154 is electronically or communicatively coupled to the controller 134. The first sensor 154 is configured to receive a portion of the first portion of the exhaust and the controller 134 is configured to estimate the average NOx of the exhaust in order to control the mixture dosed into the decomposition housing 114. Specifically, the first sensor 154 is positioned in a first sensor housing and the first sensor housing includes holes. The portion of the first portion of the exhaust flows through the holes of the first sensor housing and the first sensor 154 and controller 134 are used to calculate mass flow rate through each hole, velocity vector at the holes, and total mass flow rate in and out of the first sensor housing to estimate the average NOx of the exhaust.

The exhaust aftertreatment system 100 also includes a first exhaust sampler 156. A portion of the first exhaust sampler 156 is coupled to the first catalyst exhaust conduit 152. For example, the portion of the first exhaust sampler 156 may be fastened, welded, riveted, or otherwise attached to the first catalyst exhaust conduit 152. The first exhaust sampler 156 is positioned in the first catalyst exhaust conduit 152. The first exhaust sampler 156 is configured to receive a portion of the exhaust through a first exhaust sampler inlet and route the portion of the exhaust towards the first sensor 154 for NOx estimation. The first exhaust sampler 156 is also configured to direct the portion of the exhaust to exit the first exhaust sampler 156 and reenter the first catalyst exhaust conduit 152 through a first exhaust sampler outlet. In various embodiments, at least a portion of the first exhaust sampler 156 is positioned in the first catalyst member 144. In various embodiments, the first exhaust sampler 156 has a first exhaust sampler body that the first sensor 154 protrudes into.

In embodiments where the first catalyst member 144 includes the upstream portion 146 and the downstream portion 148 with the first sensor 154 positioned at the gap 150 between the upstream portion 146 and the downstream portion 148, as is shown in FIG. 2, the first exhaust sampler 156 is coupled to the first catalyst exhaust conduit 152 such that the first exhaust sampler 156 extends in the gap 150. By positioning the first sensor 154 and the first exhaust sampler 156 in the gap 150, the first portion of the exhaust flowing from the upstream portion 146 to the downstream portion 148 is mixed in the gap 150 before sampling, and the calculations done by the first sensor 154 and the controller 134 are more desirable. In the exhaust aftertreatment system 100 where the first exhaust sampler 156 does not extend into the gap 150 and at least a portion of the first exhaust sampler 156 is positioned in the first catalyst member 144, as is shown in FIG. 1, the portion of the exhaust sampled for the first sensor 154 includes only the exhaust in proximity to the first exhaust sampler 156 because the exhaust in the first catalyst member 144 are not mixed.

In various embodiments, such as is shown in FIG. 1, the exhaust aftertreatment system 100 also includes a second catalyst member 158 (e.g., second SCR catalyst member, etc.). The second catalyst member 158 is configured to receive, treat, and output a second portion of the exhaust output by the distributing housing 140. At least a portion of the second catalyst member 158 is positioned in the catalyst member housing 142. The second portion of the exhaust received by the distributing housing 140 is provided by the distributing housing 140 to the second catalyst member 158 (e.g., via the catalyst member housing 142, etc.). The second catalyst member 158 receives the second portion of the exhaust separately from the first portion of the exhaust that is received by the first catalyst member 144. In various embodiments, the second catalyst member 158 includes an upstream portion and a downstream portion. The upstream portion is positioned upstream of the flow of the second portion of the exhaust received by the distributing housing 140. The downstream portion is positioned downstream of the upstream portion in the direction of the flow of the first portion of the exhaust received by the distributing housing 140. The upstream portion is separated from the downstream portion by a gap.

As is explained in more detail herein, the second catalyst member 158 is configured to cause decomposition of components of the exhaust using the reductant (e.g., via catalytic reactions, etc.). Specifically, reductant that has been provided into the exhaust by the injector 126 undergoes the processes of evaporation, thermolysis, and hydrolysis to form non-NOx emissions in the distributing housing 140, the catalyst member housing 142, the second catalyst member 158, and/or the housing assembly 104. The second catalyst member 158 is configured to assist in the reduction of NOx emissions by accelerating a NOx reduction process between the reductant and the NOx of the exhaust into diatomic nitrogen, water, and/or carbon dioxide.

In various embodiments, such as is shown in FIG. 1, the exhaust aftertreatment system 100 also includes a second catalyst exhaust conduit 160. The second catalyst exhaust conduit 160 is coupled to the distributing housing 140. For example, the second catalyst exhaust conduit 160 may be fastened, welded, riveted, or otherwise attached to the distributing housing 140. The second catalyst member 158 is disposed in the second catalyst exhaust conduit 160. In various embodiments, at least a portion of the second catalyst exhaust conduit 160 is positioned in the catalyst member housing 142.

In various embodiments, such as is shown in FIG. 1, the exhaust aftertreatment system 100 also includes a second sensor 162. The second sensor 162 has the same configuration as the first sensor 154. The second sensor 162 is coupled to the second catalyst exhaust conduit 160. For example, the second sensor 162 may be fastened, welded, riveted, or otherwise attached to the second catalyst exhaust conduit 160. At least a portion of the second sensor 162 is in the second catalyst exhaust conduit 160. In embodiments where the second catalyst member 158 includes an upstream portion and a downstream portion, the second sensor 162 may be positioned at a gap between the upstream portion and the downstream portion. In various embodiments, the gap has a length that is equal to between 20% of a diameter of the second catalyst exhaust conduit 160 and 80% of the diameter of the second catalyst exhaust conduit 160, inclusive.

The second sensor 162 is electronically or communicatively coupled to the controller 134. The second sensor 162 is configured to receive a portion of the second portion of the exhaust and the controller 134 is configured to estimate the average NOx of the exhaust in order to control the mixture dosed into the decomposition housing 114. Specifically, the second sensor 162 is positioned in a second sensor housing and the second sensor housing includes holes. The portion of the second portion of the exhaust flows through the holes of the second sensor housing and the second sensor 162 and controller 134 are used to calculate mass flow rate through each hole, velocity vector at the holes, and total mass flow rate in and out of the second sensor housing to estimate the average NOx of the exhaust.

In various embodiments, such as is shown in FIG. 1, the exhaust aftertreatment system 100 also includes a second exhaust sampler 164. The second exhaust sampler 164 has the same configuration as the first exhaust sampler 156. A portion of the second exhaust sampler 164 is coupled to the second catalyst exhaust conduit 160. For example, the portion of the second exhaust sampler 164 may be fastened, welded, riveted, or otherwise attached to the second catalyst exhaust conduit 160. The second exhaust sampler 164 is positioned in the second catalyst exhaust conduit 160. The second exhaust sampler 164 is configured to receive a portion of the exhaust through a second exhaust sampler inlet and route the portion of the exhaust towards the second sensor 162 for NOx estimation. The second exhaust sampler 164 is also configured to direct the portion of the exhaust to exit the second exhaust sampler 164 and reenter the second catalyst exhaust conduit 160 through a second exhaust sampler outlet. In various embodiments, at least a portion of the second exhaust sampler 164 is positioned in the second catalyst member 158. In various embodiments, the second exhaust sampler 164 has a second exhaust sampler body that the second sensor 162 protrudes into.

In embodiments where the second catalyst member 158 includes the upstream portion and the downstream portion with the second sensor 162 positioned at the gap between the upstream portion and the downstream portion, the second exhaust sampler 164 is coupled to the second catalyst exhaust conduit 160 such that the second exhaust sampler 164 extends in the gap. By positioning the second sensor 162 and the second exhaust sampler 164 in the gap, the second portion of the exhaust flowing from the upstream portion to the downstream portion is mixed in the gap before sampling, and the calculations done by the second sensor 162 and the controller 134 are more desirable. In the exhaust aftertreatment system 100 where the second exhaust sampler 164 does not extend into the gap and at least a portion of the second exhaust sampler 164 is positioned in the second catalyst member 158, as is shown in FIG. 1, the portion of the exhaust sampled for the second sensor 162 includes only the exhaust in proximity to the second exhaust sampler 164 because the exhaust in the second catalyst member 158 are not mixed.

In various embodiments, the first portion of the exhaust is routed through the first catalyst exhaust conduit 152 in parallel with the second portion of the exhaust which is routed through the second catalyst exhaust conduit 160. By routing the first portion of the exhaust through the first catalyst exhaust conduit 152 and the second portion of the exhaust through the second catalyst exhaust conduit 160 in parallel, reduction of emission of undesirable components in the exhaust is more desirable. For example, the parallel routing of the exhaust through the first catalyst exhaust conduit 152 and the second catalyst exhaust conduit 160 may provide an increased capacity of the exhaust aftertreatment system 100 to treat exhaust and/or an increased efficiency of the exhaust aftertreatment system 100 in treating exhaust, when compared to other aftertreatment systems that do not include two catalysts and that do not route exhaust through the two catalysts in parallel.

In various embodiments, the exhaust aftertreatment system 100 does not include the second catalyst exhaust conduit 160 and the exhaust is routed only through the first catalyst exhaust conduit 152. In various embodiments, the second catalyst exhaust conduit 160 has the same configuration as the first catalyst exhaust conduit 152. Examples discussed herein relate to embodiments of the first exhaust sampler 156 positioned in the first catalyst exhaust conduit 152. Embodiments discussed may also be applied to the second exhaust sampler 164 positioned in the second catalyst exhaust conduit 160.

The housing assembly 104 also includes an outlet housing 166 (e.g., body, etc.). The outlet housing 166 is fluidly coupled to the catalyst member housing 142 and is configured to receive exhaust from the catalyst member housing 142, the first catalyst member 144, and/or the second catalyst member 158. In various embodiments, the outlet housing 166 is coupled to the catalyst member housing 142. For example, the outlet housing 166 may be fastened, welded, riveted, or otherwise attached to the catalyst member housing 142. In other embodiments, the outlet housing 166 is integrally formed with the catalyst member housing 142. The outlet housing 166 is located downstream of the catalyst member housing 142 and receives the first portion of the exhaust after flowing through the first catalyst member 144 and the second portion of the exhaust after flowing through the second catalyst member 158. In some embodiments, at least a portion of the first catalyst member 144 is positioned in the outlet housing 166 and/or at least a portion of the second catalyst member 158 is positioned in the outlet housing 166.

The exhaust aftertreatment system 100 also includes a downstream exhaust conduit 168 (e.g., line, pipe, etc.). The downstream exhaust conduit 168 is fluidly coupled to the outlet housing 166 and is configured to receive the exhaust from the outlet housing 166. In some embodiments, the downstream exhaust conduit 168 is coupled to the outlet housing 166. In other embodiments, the downstream exhaust conduit 168 is integrally formed with the outlet housing 166.

While the exhaust aftertreatment system 100 has been shown and described in the context of use with a diesel internal combustion engine, it is understood that the exhaust aftertreatment system 100 may be used with other internal combustion engines, such as gasoline internal combustion engines, hybrid internal combustion engines, propane internal combustion engines, dual-fuel internal combustion engines, and other similar internal combustion engines.

### III. First Example First Exhaust Sampler for the Exhaust Aftertreatment System

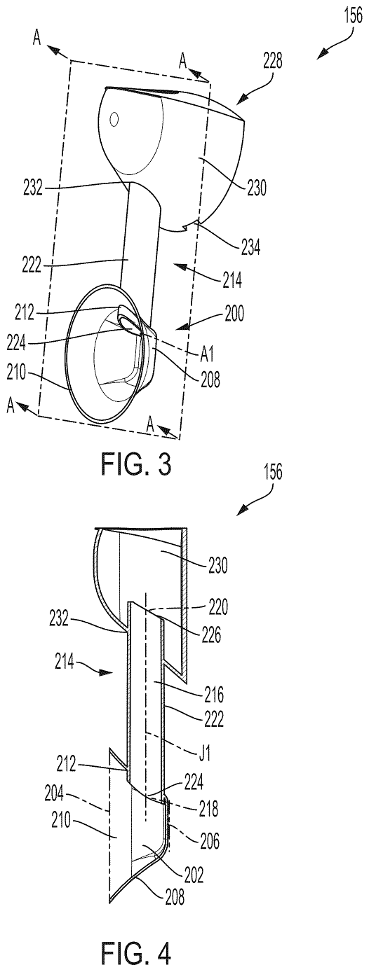

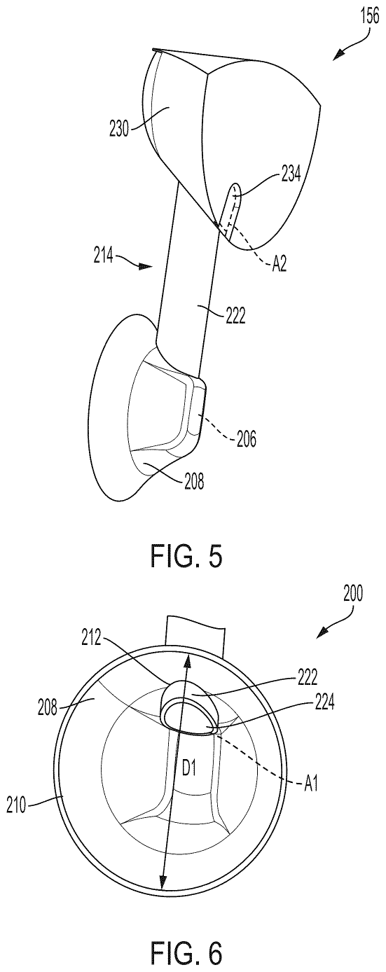

FIGS. 3-7 illustrate a first example of the first exhaust sampler 156 according to various embodiments. However, it is understood that the foregoing description of the first exhaust sampler 156 similarly applies to the second exhaust sampler 164. In various embodiments, the second exhaust sampler 164 is identical to the first exhaust sampler 156.

The first exhaust sampler 156 includes a collector 200. The collector 200 is positioned in the first catalyst exhaust conduit 152. At least a portion of the exhaust from the first catalyst member 144 flows into the collector 200. The collector 200 is configured to facilitate the flow of the portion of the exhaust to the first sensor 154. In various embodiments, at least a portion of the collector 200 is positioned in the first catalyst member 144.

The collector 200 includes a collector body 202 positioned in the first catalyst exhaust conduit 152. The collector body 202 includes a collector upstream end 204 and a collector downstream end 206. The portion of the exhaust from the first catalyst member 144 flows into the collector 200 at the collector upstream end 204, and the collector downstream end 206 is positioned downstream of the collector upstream end 204. In various embodiments, the collector upstream end 204 and the collector downstream end 206 are parallel. In various embodiments, the collector downstream end 206 has a curvature.

The collector body 202 also includes a collector wall 208. The collector wall 208 extends from the collector upstream end 204 to the collector downstream end 206. The collector wall 208 is positioned in the first catalyst exhaust conduit 152. The collector upstream end 204, the collector downstream end 206, and the collector wall 208 define the confines of the collector 200 and are the borders of the collector body 202, keeping a portion of the exhaust in the collector 200. The collector upstream end 204, the collector downstream end 206, and the collector wall 208 are configured to route the flow of the portion of the exhaust to the first sensor 154.

In various embodiments, the collector body 202 is frustoconical, as is shown in FIG. 4, or bell shaped. The collector upstream end 204 defines an upstream area. This upstream area is the entirety of the area of the collector upstream end 204. The collector downstream end 206 defines a downstream area. This downstream area is the entirety of the area of the collector downstream end 206. In these embodiments, the upstream area is greater than the downstream area. The shape of the collector body 202 contributes to a decrease in the pressure difference and an increase in the velocity of the exhaust as it flows out of the collector 200. This contributes to a more desirable sensing from the first sensor 154. In various embodiments, the collector wall 208 can have an inward curvature towards a center of the collector body 202. In various embodiments, the collector wall 208 can have an inward curvature towards a center of the collector body 202.

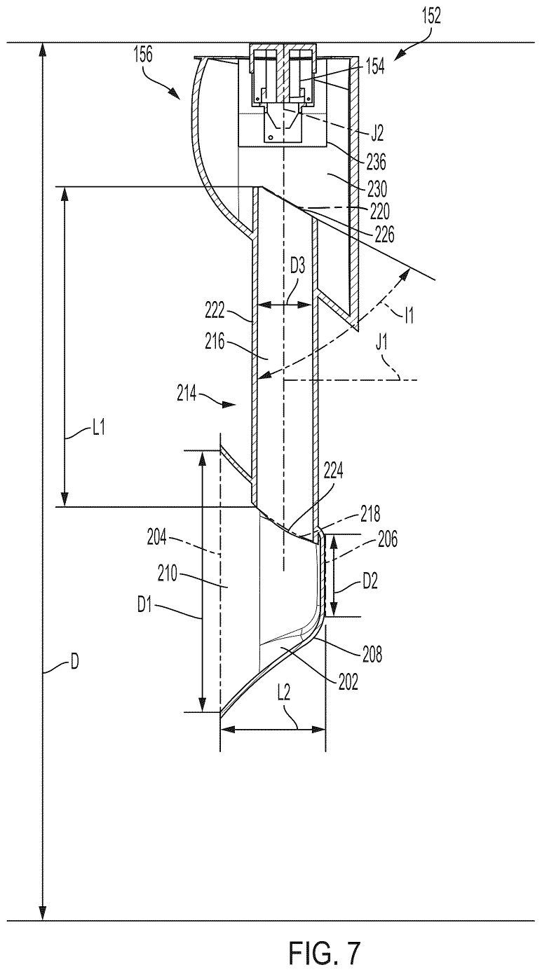

As shown in FIG. 7, the collector upstream end 204 has an upstream end diameter D1. The collector downstream end 206 has a downstream end diameter D2. The first catalyst exhaust conduit 152 has a first diameter D. In some embodiments, the collector upstream end 204 and the first catalyst exhaust conduit 152 are configured such that the upstream end diameter D1 is 25% of the first diameter D. In some embodiments, the collector upstream end 204 and the first catalyst exhaust conduit 152 are configured such that the upstream end diameter D1 is between 20% and 30%, inclusive, of the first diameter D. For example, the collector upstream end 204 and the first catalyst exhaust conduit 152 may be configured such that the upstream end diameter D1 is within (i.e., ±) 5 millimeters (mm) of the first diameter D. Additionally, in these embodiments, the collector downstream end 206 and the first catalyst exhaust conduit 152 are configured such that the downstream end diameter D2 is 6% of the first diameter D. Additionally, in these embodiments, the collector downstream end 206 and the first catalyst exhaust conduit 152 are configured such that the downstream end diameter D2 is between 1% and 6%, inclusive of the first diameter D. For example, the collector downstream end 206 and the first catalyst exhaust conduit 152 may be configured such that the downstream end diameter D2 is within (i.e., ±) 5 mm of the first diameter D.

In some embodiments, the collector upstream end 204 and the collector downstream end 206 are configured such that the downstream end diameter D2 is 24% of the upstream end diameter D1. In some embodiments, the collector upstream end 204 and the collector downstream end 206 are configured such that the downstream end diameter D2 is between 19% and 29%, inclusive, of the upstream end diameter D1. For example, the collector upstream end 204 and the collector downstream end 206 may be configured such that the downstream end diameter D2 is within (i.e., ±) 6.2 mm of the first diameter D.

The collector upstream end 204 and the collector downstream end 206 are separated by a collector end distance L2. In embodiments where the first exhaust sampler 156 is positioned within the gap 150, the collector end distance L2 is 50% of the gap length L. In some embodiments, the collector 200 is configured such that the collector end distance L2 is between 45% and 55%, inclusive, of the gap length 150. For example, the collector 200 may be configured such that the collector end distance L2 is within (i.e., ±) 5 millimeters (mm) of the gap length L.

The collector 200 also includes a collector inlet 210. The collector inlet 210 is configured to allow the exhaust to enter the collector 200. The collector inlet 210 is defined by the collector body 202 at the collector upstream end 204. In various embodiments, as is shown in FIG. 3, the collector inlet 210 is disposed at the entirety of the collector upstream end 204. In other words, the collector inlet 210 is defined by the entirety of the collector upstream end 204.

The collector 200 also includes a collector outlet 212. The collector outlet 212 is positioned at the collector body 202. The collector outlet 212 is configured to allow the exhaust to exit the collector 200. In various embodiments, the collector outlet 212 extends through the collector wall 208. In various embodiments, at least a portion of the collector outlet 212 is positioned at the collector downstream end 206. For example, the collector outlet 212 can be defined by the collector body 202 at a portion of the collector downstream end 206 at least.

The first exhaust sampler 156 also includes a transfer tube 214. The exhaust that exits the collector 200 through the collector outlet 212 flows into the transfer tube 214. The transfer tube 214 is positioned in the first catalyst exhaust conduit 152. The transfer tube is configured to facilitate the flow of the portion of the exhaust to the first sensor 154. In various embodiments, at least a portion of the transfer tube 214 is positioned in the first catalyst member 144.

The transfer tube 214 has a first center axis J1. A center point of the transfer tube 214 is positioned along the first center axis J1. In various embodiments, the transfer tube 214 is configured such that the first center axis J1 is parallel to the collector upstream end 204. The first sensor 154 has a second center axis J2 parallel to the first center axis J1. A center point of the first sensor 154 is positioned along the second center axis J2. In various embodiments, as is shown in FIG. 7, the first center axis J1 is collinear with the second center axis J2. This configuration allows for even flow of the exhaust on all sides of the first sensor 154, leading to a more even distributed sensing at the first sensor 154.

The transfer tube 214 includes a transfer tube body 216 positioned in the first catalyst exhaust conduit 152. The transfer tube body 216 includes a tube inlet end 218 and a tube outlet end 220. The exhaust flows into the transfer tube 214 at the tube inlet end 218 and exits the transfer tube 214 at the tube outlet end 220. In various embodiments, the tube inlet end 218 and tube outlet end 220 are parallel along a plane. In various embodiments, the tube inlet end 218 and the tube outlet end 220 are parallel. In various embodiments, as is shown in FIG. 7, the tube inlet end 218 and/or the tube outlet end 220 are configured such that the tube inlet end 218 and/or the tube outlet end 220 have an inclination I1 that is 50°. In various embodiments, the tube inlet end 218 and/or the tube outlet end 220 are configured such that the tube inlet end 218 and/or the tube outlet end 220 have an inclination I1 that is between 35° and 65°, inclusive.

The transfer tube body 216 includes a tube wall 222 that extends from the tube inlet end 218 to the tube outlet end 220. The tube inlet end 218, the tube outlet end 220, and the tube wall 222 define the confines of the transfer tube 214 and are the borders of the transfer tube body 216 to direct the flow of a portion the exhaust in the transfer tube 214. A portion of the tube wall 222 is coupled to the collector wall 208 around the collector outlet 212. For example, a portion of the tube wall 222 may be fastened, welded, riveted, or otherwise attached to the collector wall 208. In various embodiments, as is shown in FIG. 4, the tube wall 222 protrudes through the collector outlet 212. In other words, in various embodiments, at least a portion of the transfer tube 214 is positioned in the collector body 202.

The transfer tube 214 also includes a tube inlet 224. The exhaust exiting the collector 200 from the collector outlet 212 enters the transfer tube 214 through the tube inlet 224. The tube inlet 224 is defined by the transfer tube body 216 at the tube inlet end 218. The tube inlet 224 has an inlet area A1, which is the entirety of the area defined by the tube inlet end 218 through which the exhaust can flow into the transfer tube 214. The collector inlet 210 defines a collector inlet area, which is the entirety of the area defined by the collector upstream end 204 through which the exhaust can flow into the collector 200. In various embodiments, the collector inlet 210 is configured such that the collector inlet area is larger than the inlet area A1.

The transfer tube 214 also includes a tube outlet 226 defined by the transfer tube body 216 at the tube outlet end 220. The exhaust exits the transfer tube 214 through the tube outlet 226. The tube outlet 226 defines a tube outlet area, which is the entirety of the area defined by the tube outlet end 220 through which the exhaust can flow out of the transfer tube 214. In various embodiments, the tube outlet area is of equal value to the inlet area A1. In various embodiments, the tube outlet 226 and tube inlet 224 are parallel along a plane.

The transfer tube 214 has a tube length L1 from the tube inlet end 218 to the tube outlet end 220. The tube length L1 affects travel time and travel path for the exhaust to reach the first sensor 154, pressure of the exhaust, and the velocity at which the exhaust is reaching the first sensor 154. For example, a smaller tube length L1 results in a reduction in response time of the first sensor 154 which is desirable. In some embodiments, the transfer tube 214 and the first catalyst exhaust conduit 152 are configured such that the tube length L1 is 30% of the first diameter D. In some embodiments, the transfer tube 214 and the first catalyst exhaust conduit 152 are configured such that the tube length L1 is between 25% and 35%, inclusive, of the first diameter D. For example, the transfer tube 214 and the first catalyst exhaust conduit 152 may be configured such that the transfer tube length L1 is within (i.e., ±) 10 millimeters (mm) of the first diameter D.

The transfer tuber 214 has an internal diameter D3. In embodiments, where the first exhaust sampler 156 is positioned within the gap 150, the internal diameter D3 is 30% of the gap length L. In some embodiments, the transfer tube 214 is configured such that the internal diameter D3 is between 25% and 35%, inclusive, of the gap length 150. For example, the transfer tube 214 may be configured such that the internal diameter D3 is within (i.e., ±) 5 millimeters (mm) of the gap length L.

The first exhaust sampler 156 also includes a sensor assembly enclosure 228. The exhaust that exits the transfer tube 214 through the tube outlet 226 enters the sensor assembly enclosure 228. The sensor assembly enclosure 228 is positioned in the first catalyst exhaust conduit 152. In various embodiments, at least a portion of the sensor assembly enclosure 228 is positioned in the first catalyst exhaust conduit 152. The sensor assembly enclosure 228 is configured to route the flow of the portion of the exhaust towards the first sensor 154. The sensor assembly enclosure 228 is also configured to route the portion of the exhaust conduit out of the first exhaust sampler 156 and back into the first catalyst exhaust conduit 152.

The sensor assembly enclosure 228 includes an enclosure body 230 positioned in the first catalyst exhaust conduit 152. In various embodiments, the enclosure body 230 includes an opening to allow the first sensor 154 to protrude into the enclosure body 230. In various embodiments, the enclosure body 230 is coupled to a wall of the first catalyst exhaust conduit 152. For example, a portion of the enclosure body 230 may be fastened, welded, riveted, or otherwise attached to the first catalyst exhaust conduit 152. In various embodiments the enclosure body 230 includes an enclosure upstream end. In various embodiments, as is shown in FIG. 4, the enclosure upstream end has an outward curvature away from a center of the enclosure body 230, the curvature facilitating the flow of the exhaust to the first sensor 154, and out of the first exhaust sampler 156.

The enclosure body 230 defines a first volume, which is the entirety of the volume in the enclosure body 230 through which the exhaust can flow. The collector body 202 defines a second volume, which is the entirety of the volume in the collector body 202 through which the exhaust can flow. The collector upstream end 204, the collector downstream end 206, and the collector wall 208 serve as the boundaries of the second volume. In various embodiments, as is shown in FIG. 4, the second volume is smaller than the first volume. The second volume being smaller than the first volume results in a pressure difference and more flow separation. This is desirable for drawing the exhaust towards the first sensor 154. This configuration may also decrease backpressure in some applications. In various embodiments, the enclosure body 230 is configured such that the second volume is between 40% and 70% of the first volume, inclusive.

The sensor assembly enclosure 228 also includes an enclosure inlet 232 that extends through the enclosure body 230. A portion of the tube wall 222 is coupled to the enclosure body 230 around the enclosure inlet 232. For example, a portion of the tube wall 222 may be fastened, welded, riveted, or otherwise attached to the enclosure body 230. The exhaust that exits the transfer tube 214 through the tube outlet 226 enters the sensor assembly enclosure 228 through the enclosure inlet 232. In various embodiments, the tube wall 222 protrudes through the enclosure inlet 232. This configuration with the tube wall 222 protruding through the enclosure inlet 232 helps with directing the flow of the exhaust towards the first sensor 154. In various embodiments, at least a portion of the transfer tube 214 is positioned in the enclosure body 230.

The sensor assembly enclosure 228 also includes an enclosure outlet 234 that extends through the enclosure body 230 at a position different than the enclosure inlet 232. The enclosure outlet 234 is configured to direct the exhaust to exit the sensor assembly enclosure 228 and continue flow through the first catalyst exhaust conduit 152.

The enclosure outlet 234 has an outlet area A2, which is the entirety of the area defined by the enclosure body 230 through which the exhaust can flow out of the sensor assembly enclosure 228. The inlet area A1 is greater than the outlet area A2. The smaller outlet area A2 when compared to the inlet area A1 results in a pressure drop and a velocity increase as the exhaust flows from the tube inlet 224 to the enclosure outlet 234. This configuration helps maintain the required velocity for desirable results from the first sensor 154. In various embodiments, the inlet area A1 is between 105% and 200% of the outlet area A2, inclusive. In various embodiments, the sensor assembly enclosure 228 includes a sensor aperture 236. The sensor aperture 236 extends through the enclosure body 230. The sensor aperture 236 is configured to house at least a portion of the first sensor 154 in the enclosure body 230. The first sensor 154 projects through the sensor aperture 236 and into the enclosure body 230. In various embodiments, at least a portion of the first sensor 154 is positioned in the transfer tube body 216.

### IV. Second Example First Exhaust Sampler for the Exhaust Aftertreatment System

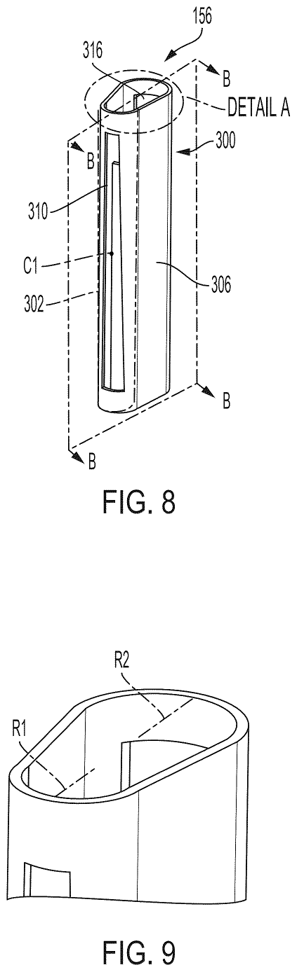

FIGS. 8-16 illustrate a second example of the first exhaust sampler 156 according to various embodiments. However, it is understood that the foregoing description of the first exhaust sampler 156 similarly applies to the second exhaust sampler 164. In various embodiments, the second exhaust sampler 164 is identical to the first exhaust sampler 156.

The first exhaust sampler 156 includes a sensor assembly enclosure 300 positioned in the first catalyst exhaust conduit 152. In various embodiments, at least a portion of the sensor assembly enclosure 300 is positioned in the first catalyst member 144. The sensor assembly enclosure 300 is configured to facilitate and route the flow of at least a portion of the exhaust from the first catalyst member 144 to the first sensor 154 and back into the first catalyst exhaust conduit 152.

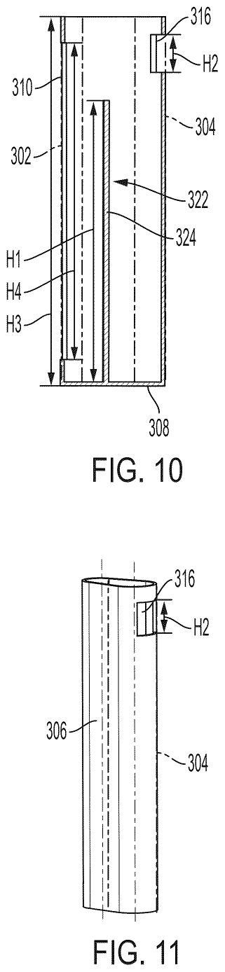

The sensor assembly enclosure 300 includes an upstream portion 302 and a downstream portion 304. The portion of the exhaust from the first catalyst member 144 flows into the sensor assembly enclosure 300 at the upstream portion 302 and the downstream portion 304 is positioned downstream of the upstream portion 302. In various embodiments, as is shown in FIG. 10, the upstream portion 302 and the downstream portion 304 are parallel.

The upstream portion 302 has an upstream portion area. The downstream portion 304 has a downstream portion area. In various embodiments, the upstream portion area is smaller than the downstream portion area. The upstream portion area being smaller than the downstream portion area results in a pressure difference and more flow separation. This is desirable for drawing the exhaust towards the first sensor 154. This configuration may also decrease backpressure in some applications. In various embodiments the downstream portion area is between 105% and 200% of the upstream portion area, inclusive.

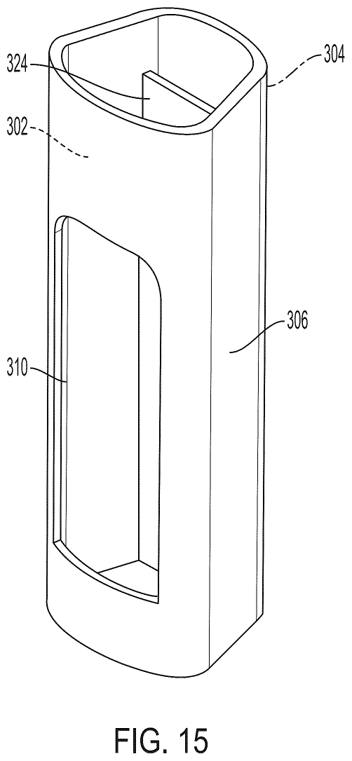

In various embodiments, as is shown in FIG. 15, the upstream portion area is larger than the downstream portion area. This configuration results in flow separation and lower pressure near the downstream portion 304 when compared to the upstream potion 302, which allows for flow to be drawn into the first exhaust sampler 156. In various embodiments the downstream portion area is between 50% and 95% of the upstream portion area, inclusive.

In various embodiments, as is shown in FIG. 9, the upstream portion 302 has a first radius of curvature R1, and the downstream portion 304 has a second radius of curvature R2. In various embodiments, a ratio of the first radius of curvature R1 to the second radius of curvature R2 is between 0.5 and 1.5, inclusive. In various embodiments, the ratio of R1 and R2 is between 1.1 and 1.5, inclusive. For example, when the upstream portion area is smaller than the downstream portion area, the ratio of R1 and R2 may be in the range of 1.1 and 1.5. In various embodiments, the ratio of R1 and R2 is between 0.5 and 0.9, inclusive. For example, when the upstream portion area is larger than the downstream portion area, the ratio of R1 and R2 may be in the range of 0.5 and 0.9.

The sensor assembly enclosure 300 also includes an enclosure wall 306 that extends from the upstream portion 302 to the downstream portion 304. The enclosure wall 306 is positioned in the first catalyst exhaust conduit 152. In various embodiments, the enclosure wall 306 is coupled to the first catalyst exhaust conduit 152 around the first sensor 154, and the first sensor 154 projects into the sensor assembly enclosure 300.

The sensor assembly enclosure 300 also includes an endcap 308 positioned in the first catalyst exhaust conduit 152. The endcap 308 extends between the upstream portion 302, the downstream portion 304, and the enclosure wall 306. The upstream portion 302, the downstream portion 304, the enclosure wall 306, and the endcap 308 define the confines and are the borders of the sensor assembly enclosure 300, preventing the exhaust in the sensor assembly enclosure 300 from exiting the sensor assembly enclosure 300 through a portion of the sensor assembly enclosure 300 other than the downstream portion 304. In various embodiments, the endcap 308 is orthogonal to the upstream portion 302 and the downstream portion 304. The endcap 308, the upstream portion 302, the downstream portion 304, and the enclosure wall 306 cooperate to define a sampler cavity.

The first exhaust sampler 156 also includes an inlet 310 configured to allow the exhaust to enter the sensor assembly enclosure 300. The inlet 310 is defined by the first exhaust sampler 156 at the upstream portion 302. The inlet 310 extends through the upstream portion 302.

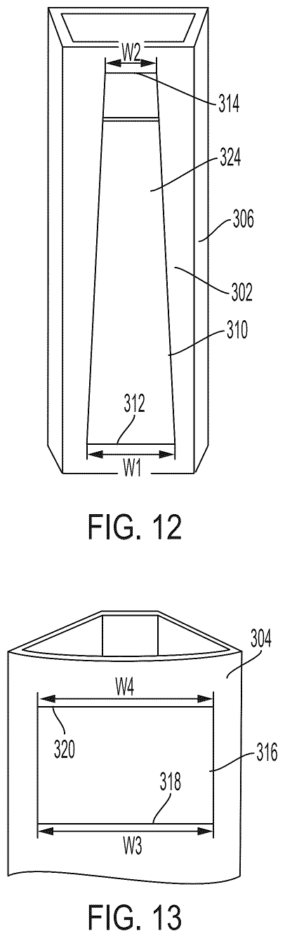

In various embodiments, as is shown in FIG. 12, the inlet 310 includes an inlet bottom edge 312 and an inlet top edge 314. The inlet bottom edge 312 and the inlet top edge 314 are parallel in a second direction orthogonal to a first direction. The first direction is orthogonal to the endcap 308. This second direction does not intersect the downstream portion 304 or the enclosure wall 306. The inlet bottom edge 312 has an inlet bottom edge width W1 defining the entirety of the width of the inlet bottom edge 312. The inlet top edge 314 has an inlet top edge width W2 defining the entirety of the width of the inlet top edge 314. In various embodiments, the inlet top edge width W2 is less than the inlet bottom edge width W1. This configuration allows for a profile of the exhaust from all areas of the inlet to be received by the first sensor 154. The first sensor 154 is positioned closer to the inlet top edge 314 than the inlet bottom edge 312. The inlet top edge width W2 being less than the inlet bottom edge width W1 takes into account that the exhaust located closer to the inlet bottom edge 312 has to travel more than the exhaust located closer to the inlet top edge 314 to reach the first sensor 154.

The first exhaust sampler 156 also includes an outlet 316 configured to allow the exhaust to exit the first exhaust sampler 156. The outlet 316 is defined by the first exhaust sampler 156 at the downstream portion 304. The outlet 316 extends through the downstream portion 304.

In various embodiments, as is shown in FIG. 13, the outlet 316 includes an outlet bottom edge 318 and an outlet top edge 320. The outlet bottom edge 318 and the outlet top edge 320 are parallel in a second direction orthogonal to a first direction. The first direction is orthogonal to the endcap 308. This second direction does not intersect the upstream portion 302 or the enclosure wall 306. The outlet bottom edge 318 has an outlet bottom edge width W3 defining the entirety of the width of the outlet bottom edge 318. The outlet top edge 320 has an outlet top edge width W4 defining the entirety of the width of the outlet top edge 320. In various embodiments, the outlet top edge width W4 is between 95% and 105% of the outlet bottom edge width W3, inclusive.

The inlet 310 has an inlet area, which is an entirety of the area defined by the upstream portion 302 through which the exhaust can flow through into the first exhaust sampler 156. The outlet 316 has an outlet area, which is an entirety of the area defined by the downstream portion 304 through which the exhaust can flow through out of the first exhaust sampler 156. The outlet area is smaller than the inlet area. The smaller outlet area when compared to the inlet area results in a pressure drop and a velocity increase as the exhaust flows from the inlet 310 to the outlet 316. This configuration helps maintain the required velocity for desirable results from the first sensor 154. In various embodiments, the outlet area is between 20% and 40% of the inlet area, inclusive.

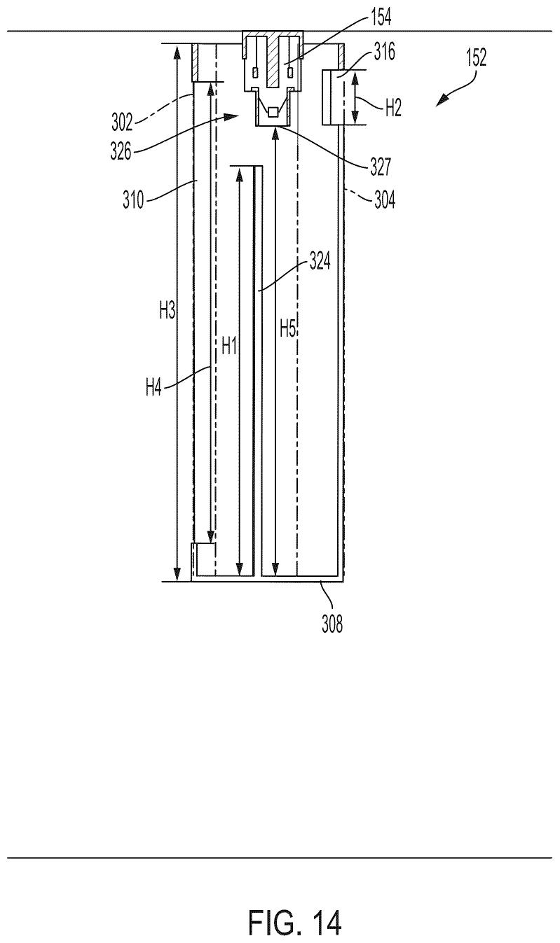

The first exhaust sampler 156 also includes a baffle plate assembly 322. The baffle plate assembly 322 is positioned in the sensor assembly enclosure 300 and disposed in the sampler cavity formed by the upstream portion 302, the downstream portion 304, and the enclosure wall 306. The baffle plate assembly 322 is configured to route the exhaust in the first exhaust sampler 156 towards the first sensor 154. In various embodiments, as is shown in FIG. 14, the baffle plate assembly 322 is positioned upstream of the first sensor 154.

The baffle plate assembly 322 includes a baffle plate 324. The baffle plate 324 is positioned in the sampler cavity between the upstream portion 302 and the downstream portion 304. The baffle plate 324 is coupled to the endcap 308. The baffle plate 324 extends in a first direction orthogonal to the endcap 308. The baffle plate 324 has a plate height H1. The plate height H1 is measured along the first direction. The position of the baffle plate assembly 322 and the plate height H1 play a role in maintain the momentum and velocity of the exhaust as it flows past the first sensor 154 and directing the exhaust to the first sensor 154. The outlet 316 has an outlet height H2. The outlet height H2 is measured along the first direction from the outlet bottom edge 318 to the outlet top edge 320. The plate height H1 is greater than the outlet height H2.

The upstream portion 302 has an upstream portion height H3 measured along the first direction. In various embodiments, the plate height H1 is less than the upstream height H3. In various embodiments, the plate height H1 is between 65% and 85% of the upstream portion height H3, inclusive. In various embodiments, the upstream portion height H3 is equal to an exhaust sampler height of the first exhaust sampler 156. The exhaust sampler height is measured along the first direction. In other words, in various embodiments, the plate height H1 does not exceed the exhaust sampler height.

The inlet 310 has an inlet height H4 measured along the first direction from the inlet bottom edge 312 to the inlet top edge 314. In various embodiments, the plate height H1 is between 70% and 90% of the inlet height H4, inclusive.

In various embodiments, the first sensor 154 includes a sensor endcap 326 that houses at least a portion of the first sensor 154. The sensor endcap 326 includes a sensor end face 327. The sensor end face 327 is on an end of the sensor endcap 326, the end most in proximity to the endcap 308. The sensor end face 327 is along a plane parallel to the endcap 308. In embodiments where the first sensor 154 projects into the sensor assembly enclosure 300, as is shown in FIG. 14, the sensor end face 327 is separated from the endcap 308 by a sensor height H5 in the first direction. In such embodiments, the sensor height H5 may be greater than the plate height H1. This configuration gives space for the exhaust to flow past the first sensor 154.

In some embodiments, the first exhaust sampler 156 also includes a second baffle plate assembly 328 positioned in the sensor assembly enclosure 300 and disposed in the sampler cavity formed by the upstream portion 302, the downstream portion 304, and the enclosure wall 306.

The second baffle plate assembly 328 also includes a second baffle plate 330 positioned in the sampler cavity between the upstream portion 302 and the downstream portion 304. The second baffle plate 330 is coupled to the endcap 308. The second baffle plate 330 extends in a first direction orthogonal to the endcap 308. The second baffle plate 330 has a plate height H6. The plate height H1 is measured along the first direction. The plate height H6 is greater than the outlet height H2.

The upstream portion 302 has a centroid (e.g., center of mass, geometric center, etc.), shown in FIG. 8 as a centroid C1. In embodiments where the first exhaust sampler 156 also includes a second baffle plate assembly 328, the baffle plate assembly 322 is separated from the centroid C1 by a first baffle distance L1. The first baffle distance L1 is in a second direction orthogonal to a direction orthogonal to the endcap 308. The second direction extends through the centroid C1. The second baffle plate assembly 328 is separated from the centroid C1 a second baffle distance L2 in the second direction. In these embodiments, the first baffle distance L1 is greater than the second baffle distance L2. In other words, the second baffle plate assembly 328 is upstream of the baffle plate assembly 322.

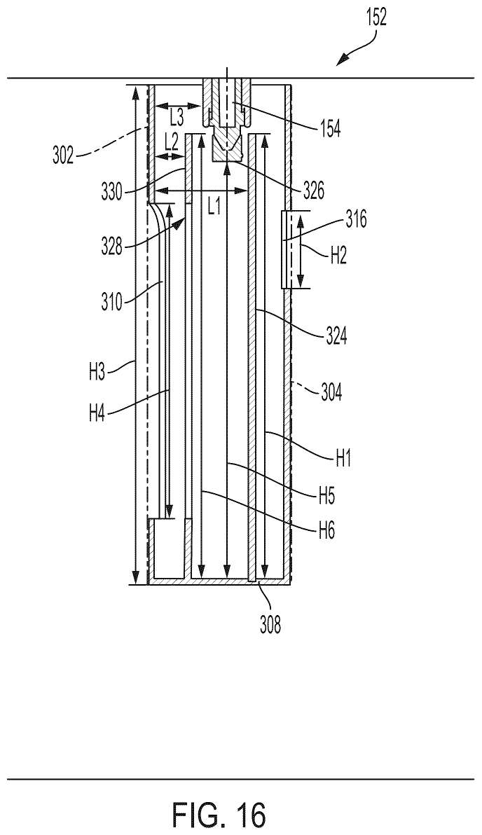

In embodiments where the first sensor 154 projects into the sensor assembly enclosure 300 that includes a second baffle plate assembly 328, as is shown in FIG. 16, the first sensor 154 is separated from the centroid C1 by a sensor distance L3. The sensor distance L3 is greater than the second baffle distance L2 and the first baffle distance L1 is greater than the sensor distance L3. In other words, the first sensor 154 is positioned between the second baffle plate assembly 328 and the baffle plate assembly 322.

### V. Configuration of Example Embodiments

While the first exhaust sampler 156 in the exhaust aftertreatment system 100 has been shown and described in the context of use with a diesel internal combustion engine, it is understood that the exhaust aftertreatment system 100 may be used with other internal combustion engines, such as gasoline internal combustion engines, hybrid internal combustion engines, propane internal combustion engines, and other similar internal combustion engines.

As utilized herein, an area is measured along a plane (e.g., a two-dimensional plane, etc.) unless otherwise indicated. This area may change in a direction that is not disposed along the plane (e.g., along a direction that is orthogonal to the plane, etc.) unless otherwise indicated.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be in the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components, or the two components and any additional intermediate components being integrally formed as a single unitary body with one another, with the two components, or with the two components and any additional intermediate components being attached to one another.

The terms “fluidly coupled to” and the like, as used herein, mean the two components or objects have a pathway formed between the two components or objects in which a fluid, such as air, reductant, an air-reductant mixture, etc., may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the various systems shown in the various example implementations is illustrative only and not restrictive in character. All changes and modifications that come in the spirit and/or scope of the described implementations are desired to be protected. It should be understood that some features may not be necessary, and implementations lacking the various features may be contemplated as in the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values in the range of values (e.g., W1 to W2 can include only W1 and W2, etc.), unless otherwise indicated.

What is claimed is:

1. An exhaust sampler comprising:
a sensor assembly enclosure comprising:
an enclosure body,
an enclosure inlet extending through the enclosure body, and
an enclosure outlet extending through the enclosure body, the enclosure outlet having an outlet area;
a collector comprising:
a collector body having a collector upstream end, and a collector downstream end opposite the collector upstream end, the collector body comprising a collector wall extending from the collector upstream end to the collector downstream end,
a collector inlet defined by the collector body at the collector upstream end, and
a collector outlet extending through the collector wall; and
a transfer tube comprising:
a transfer tube body having a tube inlet end, and a tube outlet end opposite the tube inlet end, the transfer tube body comprising a tube wall extending from the tube inlet end to the tube outlet end, the tube wall coupled to the collector wall around the collector outlet and to the enclosure body around the enclosure inlet,
a tube inlet defined by the tube wall at the tube inlet end, the tube inlet having an inlet area between 105% and 200% of the outlet area, inclusive, and
a tube outlet defined by the tube wall at the tube outlet end.

2. The exhaust sampler of claim 1, wherein the collector body is bell shaped or is frustoconical.

3. The exhaust sampler of claim 1, wherein the tube wall protrudes through at least one of the collector outlet or the enclosure inlet.

4. The exhaust sampler of claim 1, wherein:
the enclosure body has a first volume; and
the collector body has a second volume, the second volume being between 40% of the first volume and 70% of the first volume, inclusive.

5. An exhaust aftertreatment system comprising:
a catalyst exhaust conduit;
a sensor coupled to the catalyst exhaust conduit; and
the exhaust sampler of claim 1;
wherein the sensor assembly enclosure further comprises a sensor aperture extending through the enclosure body; and
wherein the sensor projects through the sensor aperture into the enclosure body.

6. The exhaust aftertreatment system of claim 5, wherein:
the transfer tube has a first center axis; and
the sensor has a second center axis, the second center axis collinear with the first center axis.

7. An exhaust sampler comprising:
a sensor assembly enclosure comprising:
an upstream portion,
a downstream portion,
an enclosure wall extending between the upstream portion and the downstream portion, and
an endcap extending between the upstream portion, the downstream portion, and the enclosure wall, the endcap cooperating with the upstream portion, the downstream portion, and the enclosure wall to define a sampler cavity;
an inlet extending through the upstream portion, the inlet having an inlet area;
an outlet extending through the downstream portion, the outlet having an outlet area, the outlet area being between 20% and 40% of the inlet area, inclusive; and
a baffle plate assembly disposed in the sampler cavity, the baffle plate assembly comprising a baffle plate coupled to the endcap and extending between the upstream portion and the downstream portion away from the endcap in a first direction orthogonal to the endcap, the baffle plate having a plate height in the first direction;
wherein the outlet has an outlet height in the first direction; and
wherein the plate height is greater than the outlet height.

8. The exhaust sampler of claim 7, wherein:
the upstream portion has an upstream portion height in the first direction; and
the plate height is between 65% and 85% of the upstream portion height, inclusive.

9. The exhaust sampler of claim 8, wherein:
the inlet has an inlet height in the first direction; and
the plate height is between 70% and 90% of the inlet height, inclusive.

10. The exhaust sampler of claim 7, wherein:
the upstream portion has a first radius of curvature;
the downstream portion has a second radius of curvature; and
the upstream portion and the downstream portion are configured such that a ratio of the first radius of curvature to the second radius of curvature is between 0.5 and 1.5, inclusive.

11. The exhaust sampler of claim 10, wherein:
the upstream portion has an upstream portion area; and
the downstream portion has a downstream portion area, the downstream portion area being between 105% and 200% of the upstream portion area, inclusive.

12. The exhaust sampler of claim 10, wherein:
the upstream portion has an upstream portion area; and
the downstream portion has a downstream portion area, the downstream portion area being between 50% and 95% of the upstream portion area, inclusive.

13. The exhaust sampler of claim 7, wherein the inlet comprises:
an inlet bottom edge having an inlet bottom edge width in a second direction orthogonal to the first direction, the second direction not intersecting the downstream portion or the enclosure wall; and
an inlet top edge having an inlet top edge width in the second direction, the inlet top edge width being less than the inlet bottom edge width, the inlet top edge being parallel to the inlet bottom edge.

14. The exhaust sampler of claim 7, wherein in the outlet comprises:
an outlet bottom edge having an outlet bottom edge width in a second direction orthogonal to the first direction, the second direction not intersecting the upstream portion or the enclosure wall; and
an outlet top edge having an outlet top edge width in the second direction, the outlet top edge width being between 95% of the outlet bottom edge width and 105% of the outlet bottom edge width, inclusive, the outlet top edge being parallel to the outlet bottom edge.

15. The exhaust sampler of claim 7, wherein:
the inlet comprises:
an inlet bottom edge having an inlet bottom edge width in a second direction orthogonal to the first direction, the second direction not intersecting the downstream portion or the enclosure wall; and
an inlet top edge having an inlet top edge width in the second direction, the inlet top edge width being less than the inlet bottom edge width, the inlet top edge being parallel to the inlet bottom edge;
the upstream portion has an upstream portion area; and
the downstream portion has a downstream portion area, the downstream portion area being between 105% and 200% of the upstream portion area, inclusive.

16. The exhaust sampler of claim 7, wherein the exhaust sampler further comprises a second baffle plate assembly comprising a second baffle plate coupled to the endcap and extending between the upstream portion and the downstream portion in the first direction, the second baffle plate having a second plate height in the first direction, and the second plate height is greater than the outlet height.

17. The exhaust sampler of claim 16, wherein:
the second baffle plate assembly is separated from a centroid of the upstream portion by a second baffle distance in a second direction orthogonal to the first direction, the second direction extending through the centroid; and
the baffle plate assembly is separated from the centroid by a first baffle distance in the second direction, the first baffle distance being greater than the second baffle distance.

18. An exhaust aftertreatment system comprising:
a catalyst exhaust conduit;
a sensor coupled to the catalyst exhaust conduit; and
the exhaust sampler of claim 7;
wherein the enclosure wall is coupled to the catalyst exhaust conduit around the sensor; and
wherein the sensor projects into the sensor assembly enclosure.

19. The exhaust aftertreatment system of claim 18, wherein:
the sensor has an end face on a sensor endcap of the sensor; and
the end face is separated from the endcap by a sensor height in the first direction, the sensor height being greater than the plate height.

20. The exhaust aftertreatment system of claim 18, wherein:
the exhaust sampler further comprises a second baffle plate assembly comprising a second baffle plate coupled to the endcap and extending between the upstream portion and the downstream portion in the first direction, the second baffle plate having a second plate height in the first direction, the second plate height being greater than the outlet height, and the second baffle plate assembly is separated from a centroid of the upstream portion by a second baffle distance in a second direction orthogonal to the first direction, the second direction extending through the centroid;
the sensor is separated from the centroid by a sensor distance in the second direction, the sensor distance greater than the second baffle distance; and
the baffle plate assembly is separated from the centroid by a first baffle distance in the second direction, the first baffle distance greater than the sensor distance.
